(19) United States
(12) Patent Application Publication
(10) Pub. No.: US 2003/0155817 A1
(43) Pub. Date: Aug. 21, 2003

(54) Super conducting action motor (acronym SCAM): electrical apparatus for generating a one-directional (ie reactionless) force, with applications in space vehicle propulsion

(76) Inventor: Benjamin La Borde, Rancho Palos Verdes, CA (US)

Correspondence Address: BENJAMIN LA BORDE, 204 ESPLANADE, IRVINE, CA, 92612-1713, US

(21) Appl. No.: 10/036,893

(22) Filed: Jan. 4, 2002

(51) Int. Cl. H02K 41/00

(52) U.S. Cl. 310/12

(57) ABSTRACT

The SCAM (Super Conducting Action Motor) is an electrical apparatus for generating a one-directional, reactionless force, in violation of Newton's III Law that each action has an equal and opposite reaction. This application exploits relativistic electrodynamics in such a way that the analysis would not be possible using conventional electromagnetic theory. The success of the SCAM depends on the status of the magnetic field being a mathematical representation, rather than a physical reality. The SCAM consists of two connected parallel plates of super-conducting elements mounted in a non-conducting substrate. Current is pulsed through the conducting elements in a controlled manner to produce unequal forces on the two plates, yielding a net force in one direction.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention pertains to the field of endeavor of electrical (electronic, or non-chemical) space propulsion systems. Within that field of endeavor the invention further pertains to the exploitation of relativistic electrodynamics and the production of a reactionless force.

### Derivation of Relativistic Electrodynamic Forces on Parallel Conductors

This section documents the derivation of equation (i), used as the basis of the force calculations in section DETAILED DESCRIPTION OF THE INVENTION.

The success of the SCAM rests on the observation that the concept of magnetic flux is a mathematical tool, not a physical reality. This derivation illustrates the equivalence of forces due to magnetic flux analysis and the relativistic effects of charged particles. The framework for this analysis is the classical parallel wire scenario. Without assuming the existence of magnetic flux the forces on the current-carrying wires are shown to satisfy the ampere definition, thus illustrating the redundancy of magnetic flux analysis in the circumstance of relativity^{[1]}. The approach rests on the hypothesis that positive and negative charges within the wires can be considered separately using a Coulomb force model. Charge invariance is maintained. In calculating the forces, four sets of interaction are considered, namely proton-proton, electron-electron, proton-electron and electron-proton. It is proposed that electron-electron and proton-proton interaction produce forces in accordance with Coulomb, since particle interaction occurs in a single rest frame in each case. However, for interaction of unlike particles, two frames must be used, moving relative to each other, due to the flow of electrons in one wire, moving with respect to the protons in the other wire. Magnetic theory is just one way of looking at the world; it tells us more about our viewpoint than about the world itself. This derivation is a specific mathematical example to show that the study of dynamic charged systems does not require the preconception of magnetic flux. This derivation does not claim to present a new philosophy—it merely revives a neglected theory^{[3]}, reinforcing it mathematically.

### Derivation

Note: if the reader is not interested in mathematics, this derivation, up to equation (i) on page 8, can be skipped without prejudice. The purpose of this derivation is to derive equation (i) relativistically.

Consider the arrangement shown in FIG. 14. Two parallel wires L and H, carrying equal currents, are separated in vacuum by a distance α.

| | |
|---|---|
| λ_{eL} | electron density in L |
| λ_{pL} | proton density in L |
| λ_{eH} | electron density in H |
| λ_{pH} | proton density in H |
| ν | electron velocity |
| δl | short current segment in L |
| δh | short current segment in H |
| μ₀ | permeability of free space |
| ε₀ | permittivity of free space |
| c | velocity of light |

The force δF on δh at point h is composed of electrostatic and electrodynamic components:

[1] Electrostatic force in the rest frame of λ_{pL} and λ_{pH}, due to the interaction of δlλ_{pL} and δhλ_{pH}; this is a repulsive force, hence denoted −ve:

$$\frac{- δ l {λ }_{{p}_{L}} δ h {λ}_{{p}_{H}}}{4 {πϵ}_{0} {r}^{2}} .$$

[2] Electrostatic force in the rest frame of λ_{eL} and λ_{eH}, due to the interaction of δlλ_{eL} and δhλ_{eH}; this is a repulsive force, hence denoted −ve:

$$\frac{- δ {l λ}_{{e}_{L}} δ h {λ}_{{e}_{H}} }{4 {πϵ}_{0} {r}^{2}} .$$

[3] Relativistic electrodynamic force in the rest frame of λ_{pL}, due to the interaction of δlλ_{pL} and δhλ_{eH}; this is an attractive force, hence denoted +ve:

$$\frac{δ l {λ}_{{p}_{L}} δ h {λ}_{{e}_{H}} \frac{δ h}{δ {h}^{′}}}{4 {πϵ}_{0} {r}^{2}}$$

where δh′ is given by the Lorentz length contraction

$$δ {h}^{′} = δ h \sqrt{1 - \frac{{v}^{2}}{{c}^{2}}} .$$

Hence this force component is

$$\frac{δ l {λ}_{{p}_{L}} δ h {λ}_{{e}_{H}}}{4 {πϵ}_{0} {r}^{2} \sqrt{1 - \frac{{v}^{2}}{{c}^{2}}}} .$$

[4] Relativistic electrodynamic force in the rest frame of λ_{pH}, due to the interaction of δlλ_{eL} and δhλ_{pH}; this is an attractive force, hence denoted +ve:

$$\frac{δ l {λ}_{{e}_{L}} \frac{δ l}{δ {l}^{′}} δ h {λ}_{{p}_{H}}}{4 {πϵ}_{0} {r}^{2}} .$$

Similarly, as in case [3], relativistic Lorentz length contraction gives

$$δ {l}^{′} = δ l \sqrt{1 - \frac{{v}^{2}}{{c}^{2}}} .$$

Hence this force component is

$$\frac{δ l {λ}_{{e}_{L}} δ h {λ}_{{p}_{H}}}{4 {πϵ}_{0} {r}^{2} \sqrt{1 - \frac{{v}^{2}}{{c}^{2}}}} .$$

The factors

$$\frac{δ h}{δ {h}^{′}}$$

in [3], and

$$\frac{δ l}{δ {l}^{′}}$$

in [4] are due to the apparent increase in charge density in a moving frame. The velocity v is the electron drift velocity, ie the current through the wire. Then from the viewpoint of the rest frame the length δh contracts to

$$δ {h}^{′} = δ h \sqrt{1 - \frac{{v}^{2}}{{c}^{2}}}$$

as illustrated in FIG. 15. (In FIG. 15, the term q denotes the charge in a small length δh. This q is introduced here for illustration only, and is not used generally in the derivation).

The total charge within δh remains unchanged, since charge is invariant under relativistic transformation. However, the length δh itself is not invariant; hence the actual charge λδh now appears to occupy a shorter length, δh′, and so the charge density appears to increase by the factor

$$\frac{δ h}{δ {h}^{′}} ,$$

ie

$$\frac{1}{\sqrt{1 - \frac{{v}^{2}}{{c}^{2}}}} .$$

Then the force δF on segment δh is the sum of the forces from [1], [2], [3] and [4]:

$$δ F = - \frac{δ l {λ}_{{p}_{L}} δ h {λ}_{{p}_{H}}}{4 {πϵ}_{0} {r}^{2}} - \frac{δ l {λ}_{{e}_{L}} δ h {λ}_{{e}_{H}}}{4 {πϵ}_{0} {r}^{2}} + \frac{δ l {λ}_{{p}_{L}} δ h {λ}_{{e}_{H}}}{4 {πϵ}_{0} {r}^{2} \sqrt{1 - \frac{{v}^{2}}{{c}^{2}}}} + \frac{δ l {λ}_{{e}_{L}} δ h {{λ}_{p}}_{H}}{4 {πϵ}_{0} {r}^{2} \sqrt{1 - \frac{{v}^{2}}{{c}^{2}}}}$$

Having derived the force δF in terms of these 4 components, the expression can now be simplified by noting that λ_{pL}=λ_{pH} and λ_{eL}=λ_{eH}. Also, since attractive and repulsive components were ascribed their appropriate signs in [1], [2], [3] and [4], all the λ terms represent the absolute charge density, so λₑ=λₚ (for L and H).

These simplifications represent notational changes only; the physical properties are unchanged. Thus

$$δ F = \frac{λλ}{4 {πϵ}_{0} {r}^{2}} ( - 1 - 1 + \frac{1}{\sqrt{1 - \frac{{v}^{2}}{{c}^{2}}}} + \frac{1}{\sqrt{1 - \frac{{v}^{2}}{{c}^{2}}}} ) δ l δ h$$

$$ie$$

$$δ F = \frac{2 λλ}{4 {πϵ}_{0} {r}^{2}} ( - 1 + \frac{1}{\sqrt{1 - \frac{{v}^{2}}{{c}^{2}}}} ) δ l δ h$$

The term

$$\frac{1}{\sqrt{1 - \frac{{v}^{2}}{{c}^{2}}}}$$

can be re-expressed by the binomial expansion for (1−x)^{-1/2}:

$$\begin{matrix}{( 1 - x )}^{- \frac{1}{2}} = 1 + \frac{x}{2} + \frac{3}{8} {x}^{2} + \frac{5}{16} {x}^{3} + \frac{35}{128} {x}^{4} + \frac{63}{256} {x}^{5} + . . . \\ ( {from ( 1 + x )}^{- \frac{1}{2}} = 1 - \frac{x}{2} + \frac{3}{8} {x}^{2} - \frac{5}{16} {x}^{3} + \frac{35}{128} {x}^{4} - \frac{63}{256} {x}^{5} + . . . ) \end{matrix}$$

Applying this to the parenthesized term in the expression for δF above,

$$\begin{matrix}- 1 + {( 1 - \frac{{v}^{2}}{{c}^{2}} )}^{- \frac{1}{2}} = - 1 + ( 1 + \frac{{v}^{2}}{2 {c}^{2}} + \frac{3}{8} \frac{{v}^{4}}{{c}^{4}} + \frac{5}{16} \frac{{v}^{6}}{{c}^{6}} + \frac{35}{128} \frac{{v}^{8}}{{c}^{8}} + \frac{63}{256} \frac{{v}^{10}}{{c}^{10}} + . . . ) \\ = \frac{{v}^{2}}{2 {c}^{2}} + \frac{3}{8} \frac{{v}^{4}}{{c}^{4}} + \frac{5}{16} \frac{{v}^{6}}{{c}^{6}} + \frac{35}{128} \frac{{v}^{8}}{{c}^{8}} + \frac{63}{256} \frac{{v}^{10}}{{c}^{10}} + . . . \end{matrix}$$

Typically the drift velocity v˜10⁻⁴ ms⁻¹, so

$$\frac{v}{c}$$

˜10⁻¹² and

$$\frac{{v}^{2}}{{c}^{2}}$$

˜10⁻²⁴. Hence

$$\frac{{v}^{2}}{2 {c}^{2}}$$

dominates in the expansion above. Using this approximation δF becomes,

$$δ F \approx \frac{2 λλ}{4 {πϵ}_{0} {r}^{2}} ( \frac{{v}^{2}}{2 {c}^{2}} ) δ l δ h$$

Given that c>>v, this approximation will now be used in equality form in the continuation of this derivation, with no significant loss of accuracy. Thus δF is expressed as

$$δ F = \frac{λλ}{4 {πϵ}_{0} {r}^{2}} \frac{{v}^{2}}{{c}^{2}} δ l δ h$$

This is the attractive force on δh, in the direction of r, due to the equal currents in wire segments δl and δh. The perpendicular force between the wires is δFₓ=δF cos θ, where cos

$$θ = \frac{a}{r}$$

$$δ {F}_{x} = \frac{λλ}{4 {πϵ}_{0} {r}^{2}} \frac{{v}^{2}}{{c}^{2}} \frac{a}{r} δ l δ h$$

Given this expression for the force attributable to small segments δl and δh on their respective wires L and H, it's now possible to find the total force on wire H by integrating over the interested lengths of the wires over their respective limits. First, the force on δh due to the entire wire L between limits l₁ and l₂ is simply the integral of δFₓ over L. Call this δFₕ:

$$δ {F}_{h} = {{\int }^{{l}_{2}}}_{{l}_{1}} \frac{λλ}{4 {πϵ}_{0} {r}^{2}} \frac{{v}^{2}}{{c}^{2}} \frac{a}{r} δ h δ l$$

The limits in l need to be expressed in terms of position h, since they are measured from δh, situated at point h.

$$δ {F}_{h} = {{\int }_{{l}_{1} - h}}^{{l}_{2} - h} \frac{λλ}{4 {πϵ}_{0} {r}^{2}} \frac{{v}^{2}}{{c}^{2}} \frac{a}{r} δ h δ l$$

Then the total force on wire H between limits h₁ and h₂, is the integral of δFₕ over H. Call this F:

$$F = {{\int }_{{h}_{1}}}^{{h}_{2}} {{\int }_{{l}_{1} - h}}^{{l}_{2} - h} \frac{λλ}{4 {πϵ}_{0} {r}^{2}} \frac{{v}^{2}}{{c}^{2}} \frac{a}{r} δ l δ h$$

Substitute in r²=α²+l² (from FIG. 14):

$$F = \frac{λλ}{4 {πϵ}_{0}} {{\int }_{{h}_{1}}}^{{h}_{2}} {{\int }_{{l}_{1} - h}}^{{l}_{2} - h} \frac{{v}^{2}}{{c}^{2}} \frac{1}{{a}^{2} + {l}^{2}} \frac{a}{{( {a}^{2} + {l}^{2} )}^{\frac{1}{2}}} δ l δ h$$

Simplify,

$$F = \frac{λλ {v}^{2}}{4 {πϵ}_{0} {c}^{2}} {{\int }_{{h}_{1}}}^{{h}_{2}} {{\int }_{{l}_{1} - h}}^{{l}_{2} - h} \frac{a}{{( {a}^{2} + {l}^{2} )}^{\frac{3}{2}}} δ l δ h$$

Substitute in

$${μ}_{0} = \frac{1}{{ϵ}_{0} {c}^{2}}$$

$$and I = λ v ( from λ = \frac{ⅆ q}{ⅆ l} , v = \frac{ⅆ l}{ⅆ t} ⇒ λ v = \frac{ⅆ q}{ⅆ l} \frac{ⅆ l}{ⅆ t} = \frac{ⅆ q}{ⅆ t} = I )$$

$$F = \frac{{μ}_{0} {I}^{2}}{4 π} {\int }_{{h}_{1}}^{{h}_{2}} {\int }_{{l}_{1} - h}^{{l}_{2} - h} \frac{a}{{( {a}^{2} + {l}^{2} )}^{3 / 2}} δ l δ h$$

The integral over l is soluble with the standard integral

$$\int \frac{ⅆ x}{{( {a}^{2} + {x}^{2} )}^{3 / 2}} = \frac{x}{{( {a}^{2} ( {a}^{2} + {x}^{2} ) )}^{1 / 2}}$$

$$F = \frac{{μ}_{0} {I}^{2}}{4 π} {\int }_{{h}_{1}}^{{h}_{2}} {[ \frac{al}{{( {a}^{2} ( {a}^{2} + {l}^{2} ) )}^{1 / 2}} ]}_{{l}_{1} - h}^{{l}_{2} - h} ⅆ h$$

Apply the limits:

$$F = \frac{{μ}_{0} {I}^{2}}{4 π a} {\int }_{{h}_{1}}^{{h}_{2}} \frac{{l}_{2} - h}{{\{ {a}^{2} + {( {l}_{2} - h )}^{2} \}}^{1 / 2}} - \frac{{l}_{1} - h}{{\{ {a}^{2} + {( {l}_{1} - h )}^{2} \}}^{1 / 2}} ⅆ h$$

This can be integrated using the standard integral:

$$\int \frac{l - x}{{( {a}^{2} + {( l - x )}^{2} )}^{1 / 2}} ⅆ x = - {\{ {a}^{2} + {( l - x )}^{2} \}}^{1 / 2}$$

$$Thus$$

$$F = {\frac{{μ}_{0} {I}^{2}}{4 π a} [ - {\{ {a}^{2} + {( {l}_{2} - h )}^{2} \}}^{1 / 2} + {\{ {a}^{2} + {( {l}_{1} - h )}^{2} \}}^{1 / 2} ]}_{{h}_{1}}^{{h}_{2}}$$

Apply the limits:

$$\begin{matrix}F = \frac{{μ}_{0} {I}^{2}}{4 π a} [ - {\{ {a}^{2} + {( {l}_{2} - {h}_{2} )}^{2} \}}^{1 / 2} + {\{ {a}^{2} + {( {l}_{1} - {h}_{2} )}^{2} \}}^{1 / 2} + \\ {\{ {a}^{2} + {( {l}_{2} - {h}_{1} )}^{2} \}}^{1 / 2} - {\{ {a}^{2} + {( {l}_{1} - {h}_{1} )}^{2} \}}^{1 / 2} ]\end{matrix} \qquad ( i )$$

This is the general form for the force on wire H along length h₂-h₁ caused by the current in wire L along length l₂-l₁. This is equation (i) used as the basis of the force calculations in section DETAILED DESCRIPTION OF THE INVENTION.

To corroborate this form consider equal lengths and alignment of lengths L and H so that h₁=l₁ and h₂=l₂. Then h₁−l₁32 0, h₂−l₂=0 and h₂−l₁=l₂−h₁=L (say). Then

$$F = \frac{{μ}_{0} {I}^{2}}{4 π a} [ - {( {a}^{2} )}^{1 / 2} + {( {a}^{2} + {L}^{2} )}^{1 / 2} + {( {a}^{2} + {L}^{2} )}^{1 / 2} - {( {a}^{2} )}^{1 / 2} ]$$

$$ie$$

$$F = \frac{{μ}_{0} {I}^{2}}{2 π a} [ {( {a}^{2} + {L}^{2} )}^{1 / 2} - a ]$$

and the force per metre is

$$\frac{F}{L} = \frac{{μ}_{0} {I}^{2}}{2 π a} [ \frac{{( {a}^{2} + {L}^{2} )}^{1 / 2}}{L} - \frac{a}{L} ]$$

For very long L such that L>>a

$$\frac{F}{L} \approx \frac{{μ}_{0} {I}^{2}}{4 π a} [ \frac{L}{L} - 0 ]$$

Finally, for the infinite wire scenario

$$\frac{L}{L} \to 1 :$$

$$\frac{F}{L} = \frac{{μ}_{0} {I}^{2}}{2 π a} {Hm}^{- 1} {A}^{2} {m}^{- 1}$$

Rationalize the units to force per unit length:

$$\frac{F}{L} = \frac{{μ}_{0} {I}^{2}}{2 π a} {Nm}^{- 1} .$$

Then for α=1 m and I=1 A,

$$\frac{F}{L} = \frac{{μ}_{0} }{2 π} = \frac{4 π \times {10}^{- 7}}{2 π} = 2 \times {10}^{- 7} {Nm}^{- 1} .$$

This is in accordance with the ampere definition of two “infinitely” long wires each carrying 1 A, separated by 1 m in vacuum:

The ampere is that steady current which when it is flowing in each of two infinitely long straight parallel wires which have negligible areas of cross-section and are 1 metre apart in vacuum, causes each conductor to exert a force of 2×10⁻⁷ N on each metre of the other.

### Requirement for a Different Perspective

This derivation demonstrates the equivalence of the relativistic electric force and those derived from magnetic flux. When electronic effects are calculated relativistically they completely describe the forces present in dynamic systems. Any attempts to then ascribe magnetic forces to such systems will always result in a magnetic flux of zero. Formidable reason to convince us of B's fiction.

Magnetic effects are attributable to a system of representation, rather than to any underlying reality. Magnetism is relativistic electronics^{[4]}.

Note that equation (i) is identical to that derived using electromagnetic analysis. Where relativistic analysis differs is as follows:

electromagnetic analysis posits that the force on wire H is attributable to its interaction with a magnetic field at wire H caused by a current in wire L.

relativistic analysis posits that the force on wire H is attributable to its interaction with an event that occurred on wire L some time earlier.

It is this small, but on-zero delay that facilitates the design of the SCAM.

Of course, magnetic analysis is very effective at describing physical systems, and is generally chosen in favor of relativistic electronics for reasons of ease. This is of course sensible, because it would be very difficult to describe engineering systems relativistically, taking account of electrons and currents as described in the preceding pages. However, it must be borne in mind that magnetic flux is a mathematical representation, having no tangible existence in its own right. The magnetic flux of a particular place (x,y,z) describes the behavior of charged particles P should they be placed there. There is no actual magnetic flux waiting there at (x,y,z). The behavior of P is in fact attributable to the presence of some other charged particles, moving relative to P, somewhere else. Of course this is the nature of field theory, preferable to the concept of action at a distance, which is clearly untenable under the causal model. Action at a distance is not proposed. The magnetic field is a consequence of static analysis of a dynamic system. This is bound to produce incongruities (magnetism) because dynamic systems require relativistic analysis^{[2]}.

### REFERENCES

[1] Albert Einstein, Annalen der Physic, xvii, 891,1905

[2] John R Lucas & Peter E Hodgeson, Spacetime and Electromagnetism, pp 187-206, Oxford University Press, ISBN 0-19-852039-5,1990

[3] Leigh Page, A Derivation of the Fundamental Relations of Electrodynamics from Those of Electrostatics, American Journal of Science, XXXIV: 57, 1912

[4] Edward M Purcell, Electricity and Magnetism, pp 169-199, McGraw-Hill, ISBN 0-17-004908-4, Second Edition 1985

### BRIEF SUMMARY OF INVENTION

The invention is an electrical apparatus for generating a one-directional, reactionless force, in violation of Newton's III Law that each action has an equal and opposite reaction. This application exploits relativistic electrodynamics in such a way that the analysis would not be possible using conventional electromagnetic theory.

The device has applications in spacecraft propulsion. Conventional spacecraft propulsion systems depend on Newton's III Law, and operate by jettisoning mass out of the spacecraft in one direction, which results in a reactive force in the opposite direction. Conventional propulsion systems thus have a limited life, determined by the time when all the propellant is exhausted.

The action motor differs from the reaction motor (rocket) in that it is all electric. This gives it a lifespan determined by the longevity of the power supply; which in the case of solar power or atomic power could be measured in decades or centuries.

The device works by virtue of the temporal lag effecting the forces experienced on a current-carrying conductor caused by a current in another conductor some distance away, and parallel to the first. By phasing the currents such that the current in one wire, L, precedes a similar current in another wire, H, H will perceive a current in L when H itself is conducting, but not contrary-wise, i.e. when L is conducting it perceives no current in H, thus experiencing no force. The small force on these two example current segments is multiplied by arranging many such segment pairs in a two-dimensional grid. FIG. 3 shows a single segment pair, and their dimension relationships. FIG. 3 also shows the arrangement of the feeder wires, aligned perpendicularly to the plate surface, in order not to interfere with the SCAM force.

### BRIEF DESCRIPTION OF THE SEVERAL VIEWS OF THE DRAWINGS

FIG. 1: current frequency Shows the current pulse profile with its 1:3 nature. Shows the pulse width (duration), p, with respect to the plate separation, a.

FIG. 2: phasing chart Shows the phase relationship of the currents in the two plates.

FIG. 3: x and z separation of 2 segments, ie segment pair Shows the dimension relationship of the separation of parallel and aligned segments, in the two plates. This figure shows the two segments of a segment pair, one segment in each plate. The segment pair is also shown with the feeder wires, aligned perpendicularly to the plate surface, in order not to interfere with the SCAM force.

FIG. 4: x and z separation of neighboring segments Shows the dimension relationships of the separation of parallel and displaced segments, in the two plates. This figure shows six segments, three in each plate. This is an overhead view, looking down between the two plates.

FIG. 5: x and y separations in a single plate Shows the dimension relationships of the separation of segments in a single plate. This figure shows twelve segments, in a 3×4 array.

FIG. 6: z and y separation in two plates Shows the dimension relationships of the separation of parallel and displaced segments, in the two plates. This figure shows eight segments, four in each plate. This is a side view looking into the plates in the direction of segment alignment: only the ends of the segments are visible (shown as dots).

FIG. 7: perspective view of the two plates Shows the three-dimensional nature of the plate arrangement—no segment detail is included.

FIG. 8: close-up perspective view of the two plates and current segments Shows the three-dimensional nature of the plate arrangement—9 segments are show in each plate, each plate having a 3×3 array.

FIG. 9: m-n segment distance relationship Shows geometric distance from Plate 1 (m,0) to Plate 2 (m,n).

FIG. 10: Force between current-carrying conducting wires Shows a theoretical parallel wire arrangement. Used to assist the electrodynamic derivation of the force between two parallel conductors, L and H of arbitrary length.

FIG. 11: Plate 1 (0,0) to Plate 2 (m,n) segment distance, B Line of sight distances used for calculating timing differences.

FIG. 12: Timing differences Shows timing differences of signals arriving at neighboring segments.

FIG. 13: Gazette view Perspective view of the two plates showing segment arrangement.

FIG. 14: Relativistic force between current-carrying conducting wires Used in the derivation of equation (i) for the relativistic forces between conductors

FIG. 15 Lorentz length contraction Shows how charge density is altered under relativistic analysis

### DETAILED DESCRIPTION OF THE INVENTION

The SCAM consists of two parallel plates of super-conducting elements mounted in a non-conducting substrate. Current is pulsed through the conducting elements in a controlled manner to produce forces on one plate, but not on the other. The best way to understand the form and function of the SCAM is to consider it from first principles. Once these principles are understood, the design follows. Two idealized parallel current-carrying conducting wires experience attractive forces according to electrodynamic form (ie relativistic form) of Coulomb's equation,

$$F = \frac{{μ}_{0} {I}^{2}}{4 π a} [ - {\{ {a}^{2} + {( {l}_{2} - {h}_{2} )}^{2} \}}^{1 / 2} + {\{ {a}^{2} + {( {l}_{1} - {h}_{2} )}^{2} \}}^{1 / 2} + {\{ {a}^{2} + {( {l}_{2} - {h}_{1} )}^{2} \}}^{1 / 2} - {\{ {a}^{2} + {( {l}_{1} - {h}_{1} )}^{2} \}}^{1 / 2} ] \qquad ( i )$$

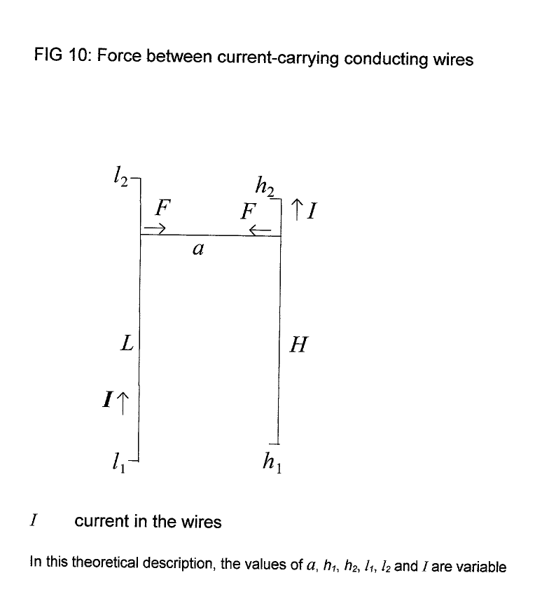

as illustrated in FIG. 10. For the derivation of (i) see section BACKGROUND OF THE INVENTION.

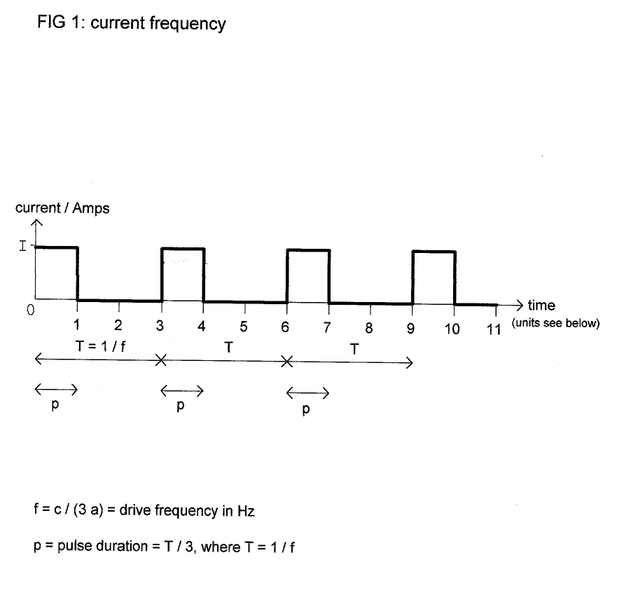

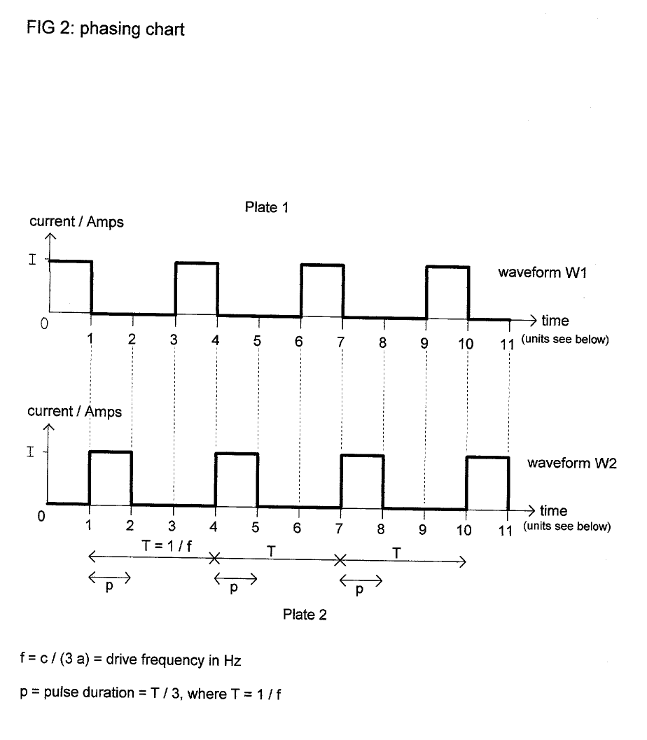

In a steady state condition, with equal current in both segments, the attractive forces are experienced by both wires. However, the signal from wire L takes a finite, non-zero time to reach wire H, that time being a/c, where a is the separation of the two wires and c is the velocity of light, in the relevant medium. This can be used to generate non-symmetric forces in L and H by pulsing current I through them as illustrated in FIG. 1 and FIG. 2.

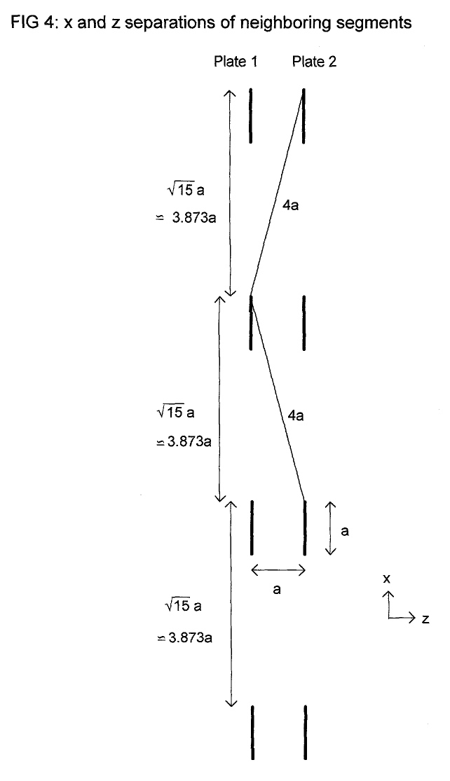

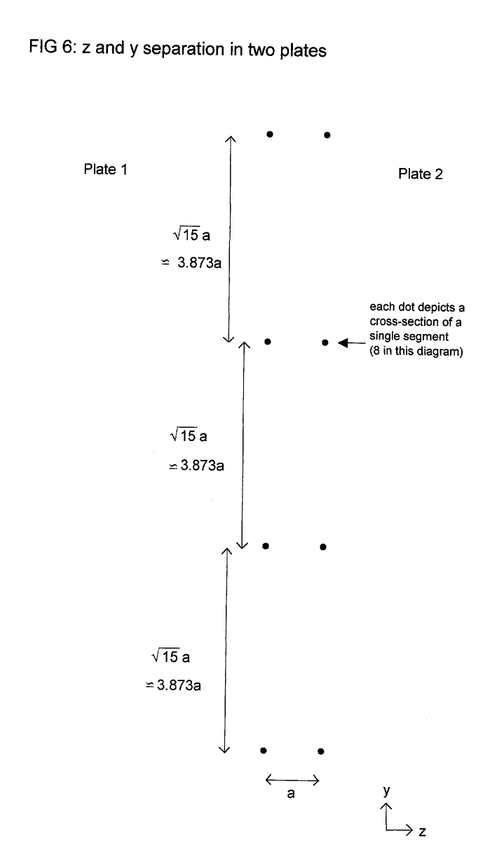

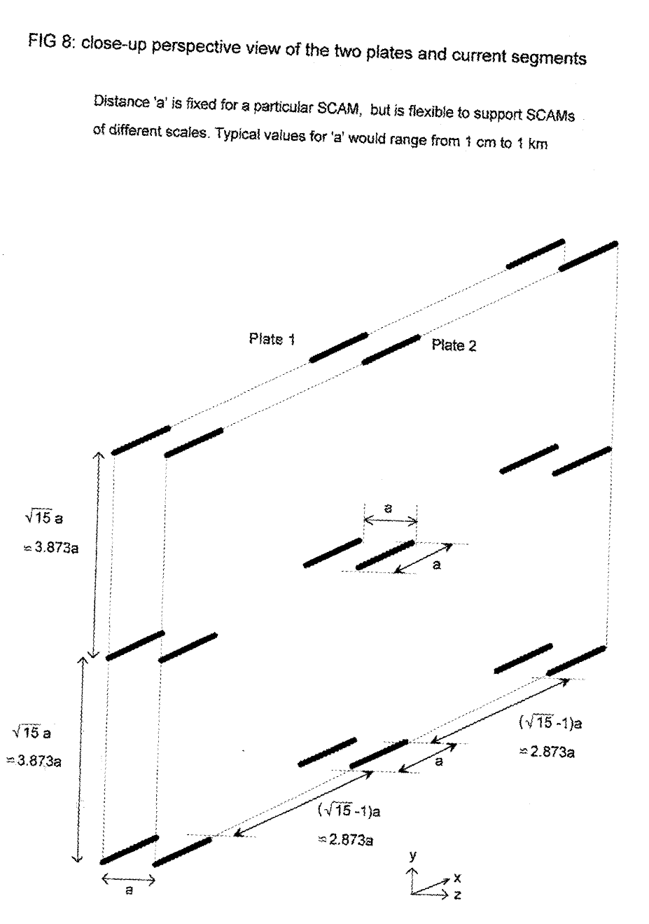

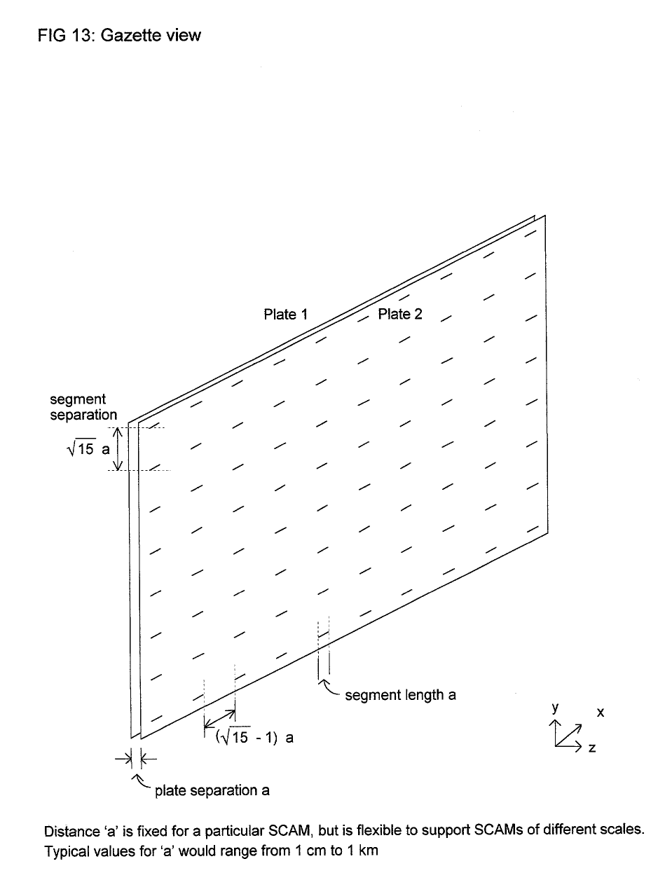

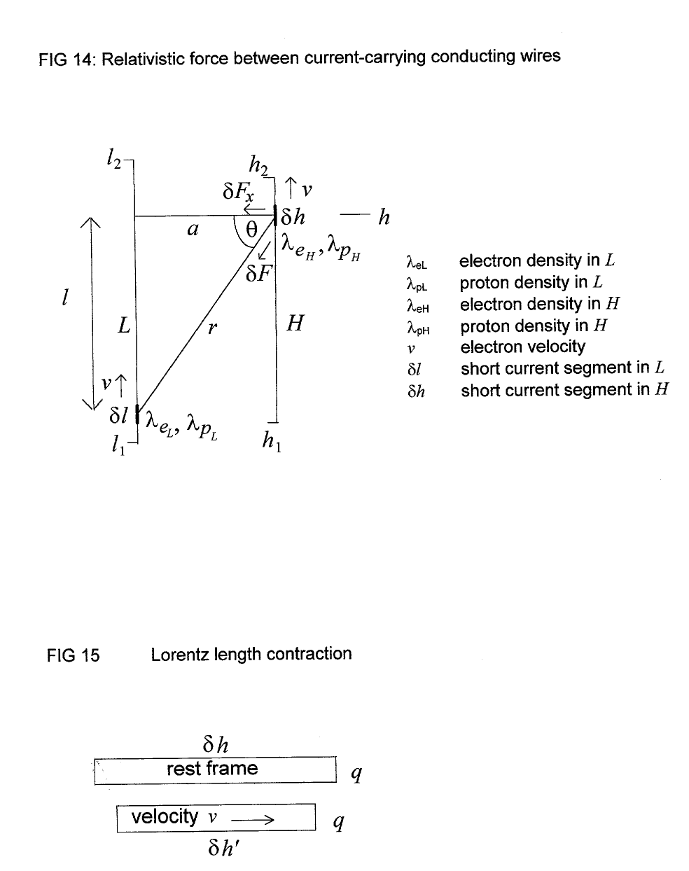

This is the basic principle of the SCAM. The one-way force is multiplied by using an array of elements, each of length a, optimally separated by gaps of length (\sqrt{15}−1)α parallel to current, and by gaps of length \sqrt{15} α normal to the current. The geometric arrangements are shown in section views in FIGS. 4, 5 and 6, and in perspective views in FIGS. 8 and 13.

### Physical Description

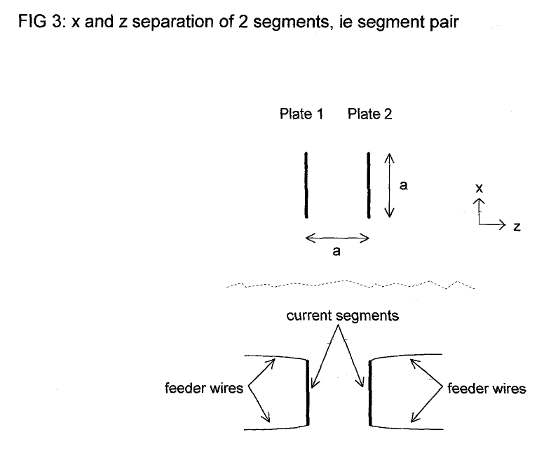

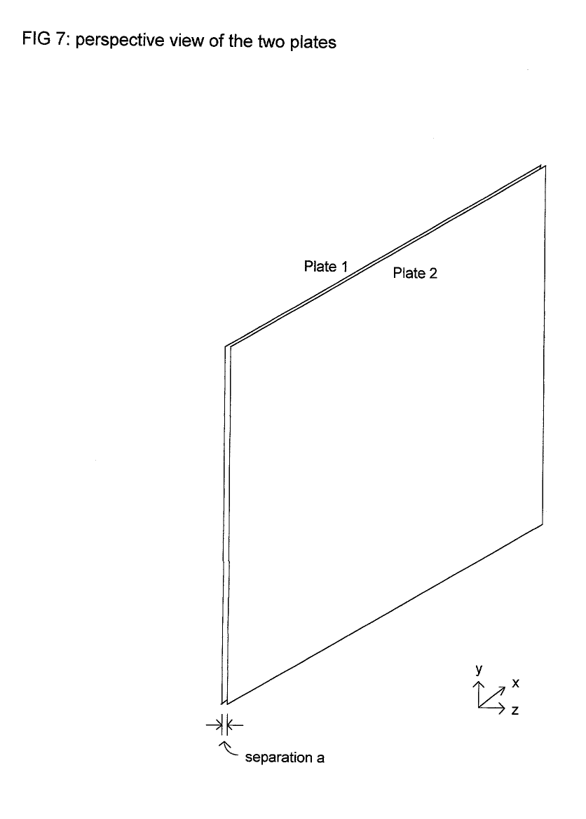

The SCAM comprises two plates of conducting segments, distance a apart, FIGS. 7 and 13. Each conducting segment is of length a, equal to the separation, FIG. 3. The two plates are rigidly connected to each other so that they cannot move relative to each other. The separation distance a is fixed for a particular SCAM, but this patent covers designs for any a. A small device might use a separation of a=1 cm. A large space-based device might use a separation of a=1 m (metre) or 1 km. The use of a large separation a facilitates the use of a lower frequency current. This scaleability will enable future devices to be built increasingly small as faster pulsing technology becomes available.

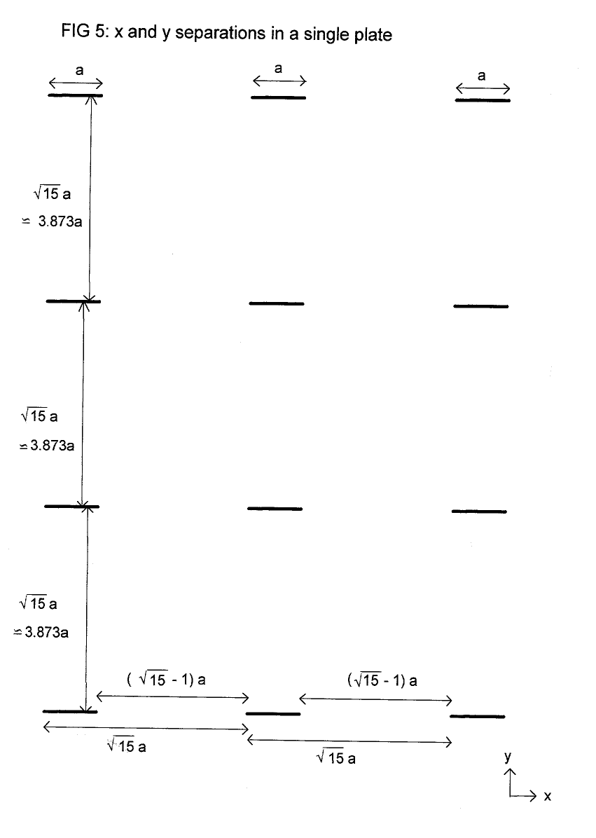

Each plate contains an array of conducting segments mounted in a non-conducting substrate, FIGS. 5, 8 and 13.

The conductors of each plate are pulsed with current I at a frequency dependent on the separation of the plates, FIG. 1.

The currents in the two plates are phased, FIG. 2.

The segment feeder wires are arranged perpendicularly to the plate surface, so as to not interfere with the plate force FIG. 3.

Each plate has M elements in the x direction, and N elements in the y direction.

M is fixed for a particular SCAM, but this patent covers designs for any M.

Similarly N is fixed for a particular SCAM, but this patent covers designs for any N.

Typical devices would use M and N in the order of 100 to 1000. M and N may be equal, but they need not be equal.

### Magnitude of the Force Produced

The net force produced by the SCAM is independent of the size of the separation a (page 18: a cancels); as far as physical dimensions are concerned, the net force depends only on M and N. So for example, a SCAM having M=N=100, a=0.1 metre, will produce the same force as a SCAM having M=N=100, a=10 metres.

The net force on the SCAM is calculated by considering the net force due to each segment in Plate 1 interacting with each segment of Plate 2. I.e. the force due to a single segment is calculated by summing the contributions from its neighboring segments on the opposite plate. The total force on the SCAM is the sum of all the forces on the individual segments.

### Individual Segment Interactions

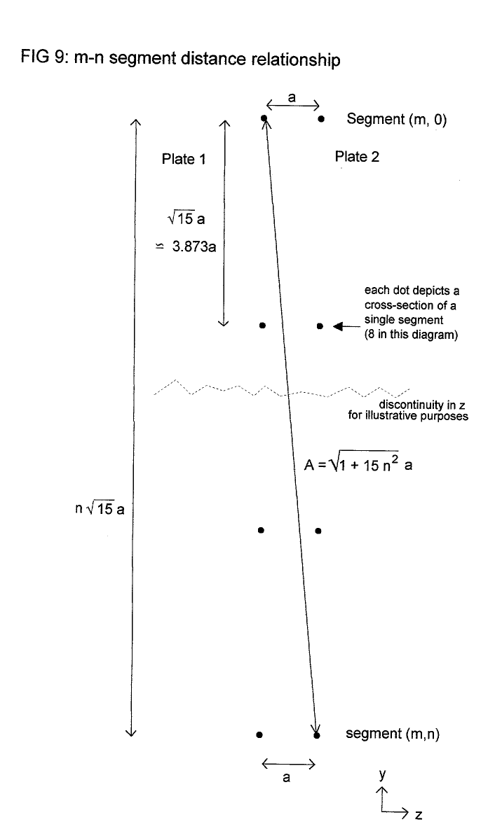

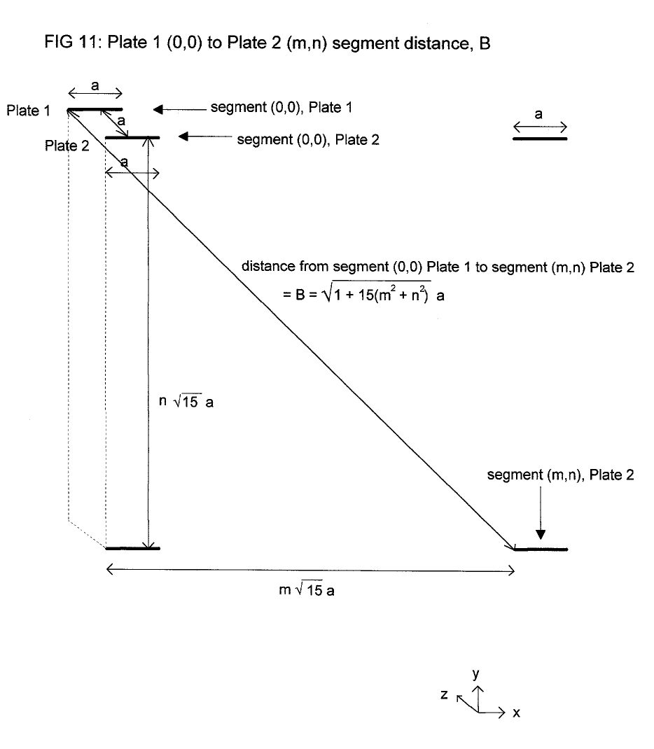

Nomenclature: in the analysis that follows, the indices m and n are relative cardinal segment displacements in x and y. Index (0,0) in Plate 1 represents the Plate 1 segment under examination (the relative origin). Indexes (m,n) represent neighboring segments in Plate 2, such that Plate 2 (0,0) is the segment pair companion of Plate 1 (0,0), see FIG. 11. F_{m,n} is the force experienced on Plate 2 (m,n) due to current in Plate 1 (0,0). From equation (i), the force between any two parallel wires is:

$$F = \frac{{μ}_{0} {I}^{2}}{4 π a} [ - {\{ {a}^{2} + {( {l}_{2} - {h}_{2} )}^{2} \}}^{1 / 2} + {\{ {a}^{2} + {( {l}_{1} - {h}_{2} )}^{2} \}}^{1 / 2} + {\{ {a}^{2} + {( {l}_{2} - {h}_{1} )}^{2} \}}^{1 / 2} - {\{ {a}^{2} + {( {l}_{1} - {h}_{1} )}^{2} \}}^{1 / 2} ]$$

Where a is the distance shown in FIG. 10. Adapting this for the SCAM, let the perpendicular segment separation be A=\sqrt{1+15n²} α as in FIG. 9:

$$F = \frac{{μ}_{0} {I}^{2}}{4 π A} [ - {\{ {A}^{2} + {( {l}_{2} - {h}_{2} )}^{2} \}}^{1 / 2} + {\{ {A}^{2} + {( {l}_{1} - {h}_{2} )}^{2} \}}^{1 / 2} + {\{ {A}^{2} + {( {l}_{2} - {h}_{1} )}^{2} \}}^{1 / 2} - {\{ {A}^{2} + {( {l}_{1} - {h}_{1} )}^{2} \}}^{1 / 2} ]$$

Substitute in values μ₀=4π×10⁻⁷ Hm⁻¹, l₁=0, l₂=α, h₁=m\sqrt{15} α, h₂=m\sqrt{15} α+α

$$F = \frac{{10}^{- 7} {I}^{2}}{ A} [ - {\{ {A}^{2} + 15 {m}^{2} {a}^{2} \}}^{1 / 2} + {\{ {A}^{2} + {( ma \sqrt{15} + a )}^{2} \}}^{1 / 2} + {\{ {A}^{2} + {( m \sqrt{15} - a )}^{2} \}}^{1 / 2} - {\{ {A}^{2} + 15 {m}^{2} {a}^{2} \}}^{1 / 2} ]$$

Substitute in A²=α²+n²15α²=α²(1+15n²)

$$F = {\frac{{10}^{- 7} {I}^{2}}{a \sqrt{1 + 15 {n}^{2}}} [ - {a}^{2} ( 1 + 15 {n}^{2} ) + 15 {m}^{2} {a}^{2} \}}^{1 / 2} + {\{ {a}^{2} ( 1 + 15 {n}^{2} ) + {( m \sqrt{15} + 1 )}^{2} {a}^{2} \}}^{1 / 2} + {\{ {a}^{2} ( 1 + 15 {n}^{2} ) + {( m \sqrt{15} - 1 )}^{2} {a}^{2} \}}^{1 / 2} - {\{ {a}^{2} ( 1 + 15 {n}^{2} ) + 15 {m}^{2} {a}^{2} \}}^{1 / 2} ]$$

α cancels

$$F = {\frac{{10}^{- 7} {I}^{2}}{\sqrt{1 + 15 {n}^{2}}} [ - {\{ 1 + 15 {n}^{2} + 15 {m}^{2} \}}^{1 / 2} + \{ 1 + 15 {n}^{2} ) + {( m \sqrt{15} + 1 )}^{2} \}}^{1 / 2} + {\{ 1 + 15 {n}^{2} + {( m \sqrt{15} - 1 )}^{2} \}}^{1 / 2} - {\{ 1 + 15 {n}^{2} + 15 {m}^{2} \}}^{1 / 2} ]$$

collect terms:

$$\begin{matrix}F = \frac{{10}^{- 7} {I}^{2}}{\sqrt{1 + 15 {n}^{2}}} [ - 2 {\{ 1 + 15 {n}^{2} + 15 {m}^{2 } \}}^{1 / 2} + \\ {\{ 1 + 15 {n}^{2} + {( m \sqrt{15} + 1 )}^{2} \}}^{1 / 2} + \\ {\{ 1 + 15 {n}^{2} + {( m \sqrt{15} - 1 )}^{2} \}}^{1 / 2} ]\end{matrix}$$

Segment forces calculated with this equation are shown in Table 1 (over page).

TABLE 1
Force F_{m,n}/Newtons(×I²)

| | m = 0 | m = 1 | m = 2 | m = 3 | m = 4 |
|---|---|---|---|---|---|
| n = 0 | 8.284271E−08 | 1.657607E−09 | 2.133211E−11 | 6.351320E−11 | 2.688900E−11 |
| n = 1 | 6.155281E−09 | 2.343748E−09 | 6.096187E−10 | 2.168178E−10 | 9.800905E−11 |
| n = 2 | 1.632680E−09 | 1.178737E−09 | 6.885852E−10 | 2.855185E−10 | 1.499315E−10 |
| n = 3 | 2.389474E−10 | 6.279738E−10 | 4.252823E−10 | 2.617651e−10 | 1.601844E−10 |
| n = 4 | 4.145082E−10 | 3.787467E−10 | 2.972741E−10 | 2.130374E−10 | 1.472746E−10 |

To illustrate the plate force, consider a SCAM of size M×N=2×3, as depicted in the non-shaded cells of Table 1. Due to symmetry, F_{±m,±n}=F_{m,n}

### Timing Differences

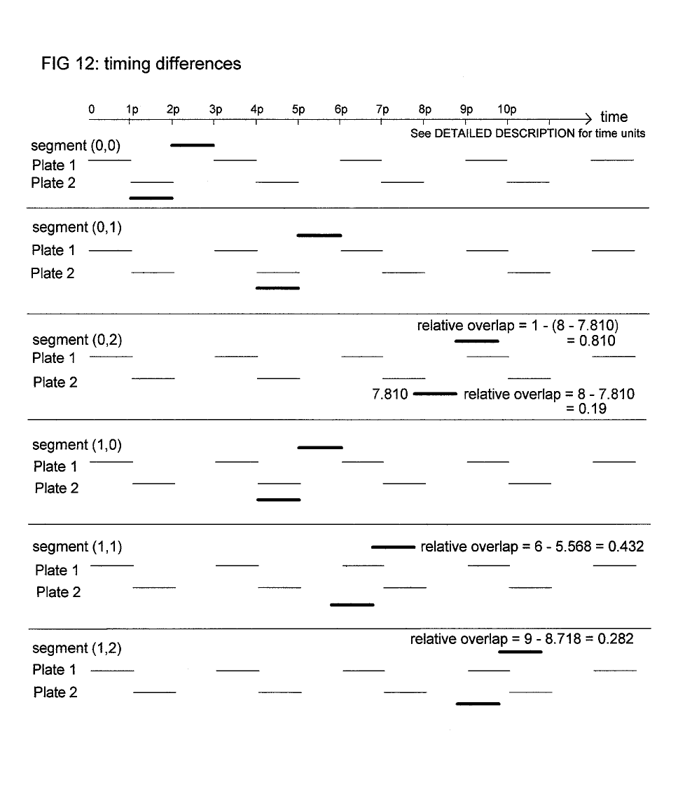

The forces in Table 1 need to be adjusted to recognize the partial Plate 1 and Plate 2 forces attributable to timing differences. In the ideal situation, as occurs in segment (m,n) and its four nearest neighbors, the Plate 1 contribution is 0% and the Plate 2 contribution is 100%. This ideal does not extend to the more distant neighbors due to Plate 1 to Plate 2 segment separations not being exact multiples of (1+3J)a, where J is an integer and a is the plate separation. Timing differences are illustrated in FIG. 12, based on the line-of-sight segment distances, B, from FIG. 11. From FIG. 11, B=\sqrt{1+15(m²+n²)} α Line of sight distances for the unshaded segments of Table 1 are shown below:

TABLE 2
Line-of-sight distances from Plate 1 (0.0) to Plate 2 (m,n)

| | m = 0 | m = 1 |
|---|---|---|
| n = 0 | a | 4a |
| n = 1 | 4a | \sqrt{31} a = 5.568 a |
| n = 2 | \sqrt{61} a = 7.810 a | \sqrt{76} a = 8.718 a |

### Explanation of FIG. 12

Time proceeds along the abscissa axis, left to right. For each segment, (m,n) the current pulses are shown for Plate 1 above, and for Plate 2 below. The thicker bottom line then shows the arrival of the Plate 1 (0,0) signal at Plate 2 (m,n); and the thicker top line shows the arrival of the Plate 2 (m,n) signal at Plate 1 (0,0). The overlap of the Plate 1 (0,0) signal with Plate 2 (m,n) produces an attractive force on Plate 2 which is beneficial to the net force on the SCAM. Contrary-wise, the overlap of the Plate 2 (m,n) signal on Plate 1 (0,0) produces an attractive force on Plate 1 which is detrimental to the SCAM. From FIG. 12, the augmenting factors for the unshaded segments of Table 1 are as follows:

TABLE 3
Segment multiplicative timing adjustments

| | m = 0 | m = 1 |
|---|---|---|
| n = 0 | 1 | 1 |
| n = 1 | 1 | −0.432 |
| n = 2 | −0.62 | −0.282 |

Applying these multiplicative factors to the non-shaded elements of Table 1 yields:

TABLE 4
Augmented forces of Table 1 and Table 3/Newtons (×I²)

| | m = 0 | m = 1 |
|---|---|---|
| n = 0 | 8.284271E-08 | 1.657607E-09 |
| | A | D |
| n = 1 | 6.155281E-09 | −1.012499E-09 |
| | B | E |
| n = 2 | −1.012261E-09 | −3.324038E-10 |
| | C | F |

For simplicity, the cells (0,0), (0,1), (0,2), (1,0), (1,1) and (1,2) above have been labeled A, B, C, D, E, and F respectively. Then the plate force, Fₚ, is:

Fₚ=F_{0,0}+F_{0,1}+F_{0,2}+F_{1,0}+F_{1,1}+F_{1,2}

Where each F_{m,n} is the sum of the six segments on the opposing plate. Then, taking account of the symmetry, F_{±m,±n}=F_{m,n,} the total SCAM force for the 2×3 example is the sum of the six components:

F_{0,0}=A+B+C+D+E+F=8.829843×10⁻⁸ I²

F_{0,1}=A+B+B+D+E+E=9.478588×10⁻⁸ I²

F_{0,2}=A+B+C+D+E+F=8.829843×10⁻⁸ I²

F_{1,0}=A+B+C+D+E+F=8.829843×10⁻⁸ I²

F_{1,1}=A+B+B+D+E+E=9.478588×10⁻⁸ I²

F_{1,2}=A+B+C+D+E+F=8.829843×10⁻⁸ I²

Then using

Fₚ=F_{0,0}+F_{0,1}+F_{0,2}+F_{1,0}+F_{1,1}+F_{1,2,}

Fₚ5.427655×10⁻⁷ I²

and the average force per segment is

$$\frac{5.427655 \times {10}^{- 7}}{6} {I}^{2} = 9.046091 \times {10}^{- 8}$$

The above analysis is applied to plates of various dimensions as shown below. The numbers show the plate dimension, M×N, the total SCAM force, and the average force per segment pair.

TABLE 5
Force (in Newtons) calculations for various SCAM sizes

| M × N | total force (×I²) | average force per segment (×I²) |
|---|---|---|
| 1 × 1 | 8.284 × 10⁻⁸ | 8.284 × 10⁻⁸ |
| 2 × 2 | 3.586 × 10⁻⁷ | 8.964 × 10⁻⁸ |
| 2 × 3 | 5.428 × 10⁻⁷ | 9.046 × 10⁻⁸ |
| 3 × 3 | 8.099 × 10⁻⁷ | 8.998 × 10⁻⁸ |
| 4 × 4 | 1.432 × 10⁻⁶ | 8.949 × 10⁻⁸ |
| 5 × 5 | 2.232 × 10⁻⁶ | 8.929 × 10⁻⁸ |
| 10 × 10 | 8.846 × 10⁻⁶ | 8.846 × 10⁻⁸ |
| 20 × 20 | 3.518 × 10⁻⁵ | 8.795 × 10⁻⁸ |
| 50 × 50 | 2.190 × 10⁻⁴ | 8.761 × 10⁻⁸ |
| 100 × 100 | 8.749 × 10⁻⁴ | 8.749 × 10⁻⁸ |

These numbers were calculated using a computer program. The 100×100 case took just over 27 hours to complete. For this reason, forces for M, N>100 were not calculated. However, it can be seen from the averages that for large SCAM size, the average force per segment, Fₛ, is approximately 8.7×10⁻⁸ I². This force is further augmented by the ⅓ temporal pulse used as the segment current, (FIGS. 1 and 2) thus reducing the effective force by a factor of 3:

Fₛ≅8.8×10⁻⁸/3 I² Newtons

Fₛ≅2.9×10⁻⁸ I² Newtons

Example SCAM applying the above force to plates of 1000×1000 segments carrying 100 Amps:

M=N=1000

I=100 Amps

SCAM force Fₚ=M×N×Fₛ×I×I Newtons

SCAM force Fₚ=1000×1000×2.9×10⁻⁸×100×100=290 N

As technology advances, it will become possible to build SCAMs of higher and higher frequency, facilitating a smaller separation, a, and larger M and N values. Similarly, as superconductor technology advances, SCAMs will be able operate at higher currents. Consider a case where

M=N=100000

and

I=1000 Amps,

then using

SCAM force Fₚ=M×N×Fₛ×I×I Newtons

SCAM force Fₚ=100000×100000×2.9×10⁻⁸×1000×1000=290,000,000 N

What I claim as my invention is:

1. The SCAM produces a reactionless, one-directional force, in contradiction of Newton's III Law; the one-directional force is a claim of this patent.

2. The SCAM comprises 2 parallel plates of conducting segments distance a apart;
each segment is of length a, equal to the separation; separation distance a is fixed for a particular SCAM, but this patent covers designs for any a; the use of any separation distance a is a claim of this patent.

3. This patent claims all values of a.

4. Each conducting segment is of length a, equal to the separation; the equivalence of plate separation and segment length is a claim of this patent.

5. The conductors of each plate are pulsed with current I at a frequency dependent on the separation of the plates, as in FIGS. 1 and 2.

6. The currents in the two plates are phased, as in W1 and W2 of FIG. 2; these wave forms and phase relationship is a claim of this patent.

7. Each plate has M elements in the x direction, and N elements in the y direction; M is fixed for a particular SCAM, but this patent covers designs for any M.

8. Similarly N is fixed for a particular SCAM, but this patent covers designs for any N.

9. M and N may be equal, but they need not be equal. This patent claims all values for M and N.

10. The array of segments, are separated by gaps of (\sqrt{15}−1)α parallel to current (the x direction), and by gaps of \sqrt{15} α normal to the current (the y direction) (FIGS. 5 and 8); these separations,(\sqrt{15}−1)α and \sqrt{15} α are part of this patent; this patent claims the x and y segment separations (\sqrt{15}−1)α and \sqrt{15} α

11. The individual segments may be fabricated from conventional conductors or superconductors.

12. Although the SCAM depicted has rectangular plates, this patent covers plates of any shape.

13. To guard against infringement of this patent using sub-optimal geometric variation, this patent claims all dimensions and ratios specified in the specification, ±75%.
